(19) United States
(12) Patent Application Publication
(10) Pub. No.: US 2019/0314863 A1
(43) Pub. Date: Oct. 17, 2019

(54) BEATER BAR CLEANER

(71) Applicant: Dirk Matthew VandenBergh, Santee, CA (US)

(72) Inventor: Dirk Matthew VandenBergh, Santee, CA (US)

(21) Appl. No.: 15/954,004

(22) Filed: Apr. 16, 2018

(51) Int. Cl. B08B 1/00; A47L 9/04

(52) U.S. Cl. CPC B08B 1/005; A47L 9/0477

(57) ABSTRACT

A device for cleaning a beater bar of a vacuum cleaner includes a flexible body with an elongated rubber strip with blades attached that is so positioned as to be parallel to the beater bar when the device is disposed for cleaning the beater bar; blades penetrating the elongated opening under a vacuum for pulling, tearing and cutting hair and debris from the beater bar. The device is particularly useful for cleaning hair and debris off of beater bars in vacuum cleaners.

### BACKGROUND

The invention pertains to a device for cleaning a vacuum cleaner beater bar, which also is known as a vacuum cleaner roller brush, a brush roller, or a bristle bar. The vacuum cleaner beater bar is the rotating brush on the bottom of a vacuum cleaner and is referred to herein as a “beater bar”. The beater bar agitates a carpet to fluff up the carpet loosen dirt and remove hair while allowing the vacuuming power to suck up embedded dirt and debris. Hair and debris can get caught in the brush bristles requiring cleaning in order to optimize functionality of the beater bar. Cleaning a beater bar required scissors and other sharp objects or pulling the hair off of the beater bar by hand. Removing the beater bar from the vacuum cleaner has also been necessary at times for thorough cleaning. Removing the debris from the beater bar by hand has had positive results. However; the process is time consuming and unsanitary.

The blades on this device are commonly called a pin, nail, staple, or blade, and is referred to herein as a “blade”.

### SUMMARY OF THE INVENTION

The invention provides a device for cleaning a beater bar of a vacuum cleaner, comprising: a body with an elongated opening that is so positioned as to be parallel to the beater bar when the device is disposed for cleaning the beater bar; metal blades penetrating the elongated opening on the bottom of a vacuum for pulling, tearing and cutting hair and debris from the beater bar. The beater bar cleaning device removes hair and other debris that can get caught in the brush bristles of a beater bar. This beater bar cleaning device alleviates the need to handle or remove the beater bar by hand for cleaning; and thereby provides an efficient and cleaner way to clean the vacuum beater bar.

This beater bar cleaning device can be used to clean the beater bar of many different models of a vacuum cleaner with a beater bar; and cleaning time is significantly reduced. The present invention provides a body comprising of a solid material. The elongated rectangular rubber strip with attached metal blades are positioned parallel to the beater bar in order to pull, tear and cut hair and debris and thereby allows the debris to be sucked into the vacuum cleaner.

Additional features of the present invention are described with reference to the detailed description.

### BRIEF DESCRIPTION OF THE DRAWING

FIG. 1 illustrates an isometric view of one embodiment of the vacuum beater bar cleaner according to the present invention.

FIG. 2 illustrates a top view of the vacuum beater bar cleaner device depicted in FIG. 1.

FIG. 3 illustrates the side view of the vacuum beater bar cleaner device depicted in FIG. 1.

### DETAILED DESCRIPTION

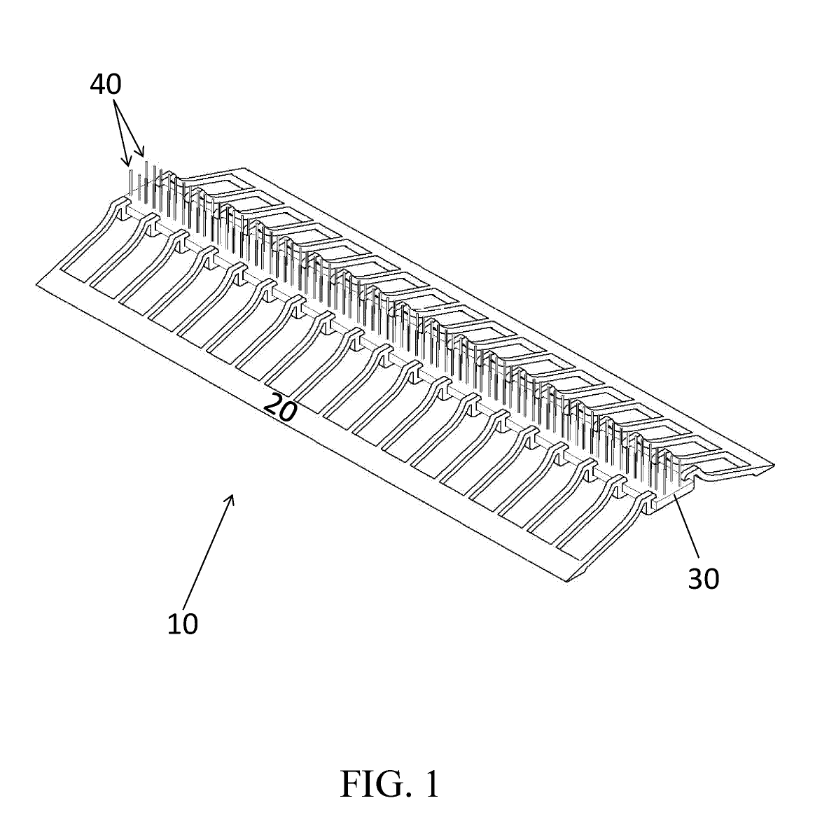

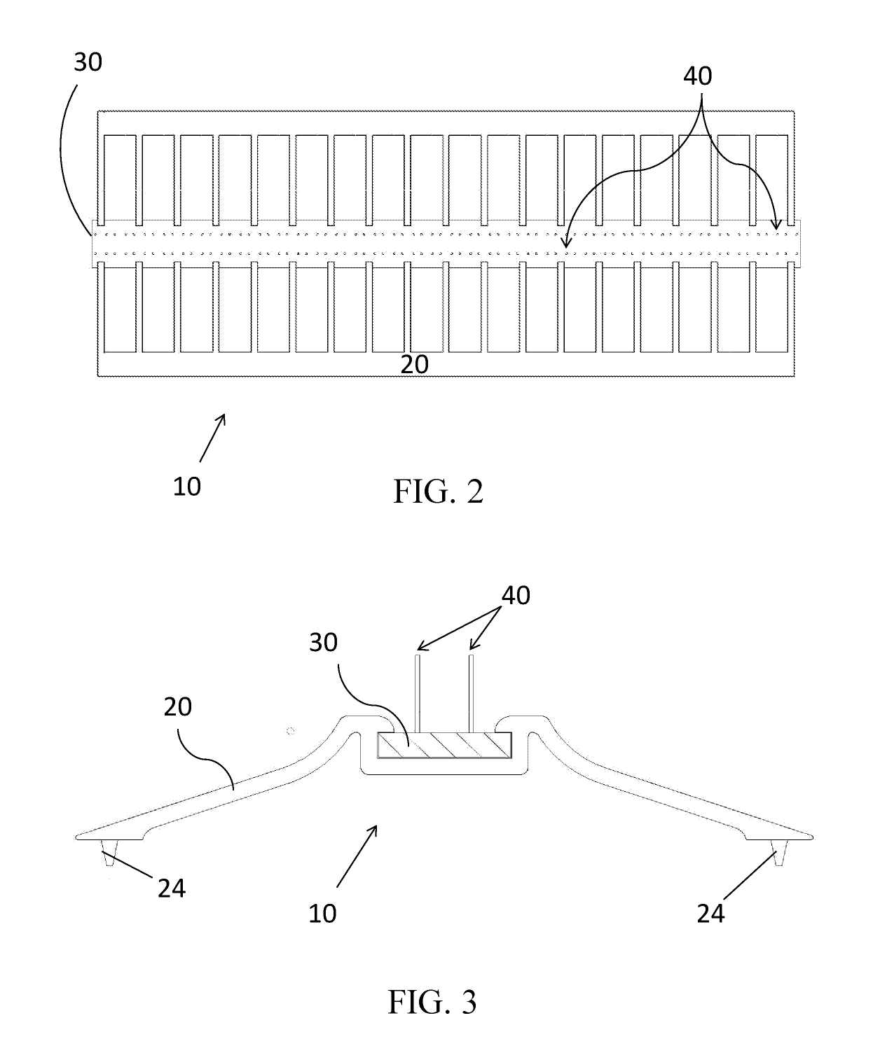

FIGS. 1, 2, and 3 show an exemplary embodiment of a beater bar cleaning device 10 according to the invention. Preferably, the body 20 is made of a flexible solid material and has an elongated rubber strip on top 30. Blades 40 protrude up through the rectangular rubber strip 30 forming a straight line or lines. Preferably the blades 40 are metal. At the base of the body 20, rows of protruding teeth 24 are attached. The teeth 24 hold the beater bar cleaning device 10 in place on a carpeted surface.

A vacuum cleaner is maneuvered onto the beater bar cleaning device 10, so that the beater bar is centered over the metal blades 40. The blades 40 and body 20 flex downward under the weight of a vacuum cleaner when the vacuum cleaner is pushed on top of the blades. The flexibility of the blades 40 and body 20 allows the remaining blades 40 that are not in contact with the base of the vacuum cleaner to make contact with the beater bar.

The vacuum cleaner is so positioned that the beater bar can rotate over the blades 40, which pull, tear and cut hair and remove debris from the beater bar.

The vacuum cleaner motor should be turned on in order for the beater bar to be in motion over the blades.

Different embodiments of a beater bar cleaning device according to the invention are configured for use with vacuum cleaners of different dimensions.

The benefits specifically stated herein do not necessarily apply to every conceivable embodiment of the invention. Further, such stated benefits of the invention are only examples and should not be construed as the only benefits of the invention.

While the above description contains much specificity, these specifics are not to be construed as limitations on the scope of the invention, but rather as examples of the embodiments described herein. Other variations are possible and the scope of the invention should be determined not by the embodiments described herein but rather by the claims and their legal equivalents.

1. A device for cleaning a beater bar of a vacuum cleaner, comprising:
a body with an elongated rubber strip with attached blades that is so positioned as to be parallel to the beater bar when the device is disposed for cleaning the beater bar;
blades penetrating the elongated opening under the bottom of a vacuum for pulling, tearing and cutting hair and debris from the beater bar.

2. The device of claim 1 wherein said body is comprised of at least one of the following materials: wood, metal or plastic.

3. The device of claim 1 wherein said vacuum beater bar cleaning device further comprises of a flexible strip made of rubber.

4. The device of claim 1 wherein said vacuum beater bar cleaning device further comprises blades made of metal.
